(19) United States
(12) Patent Application Publication
(10) Pub. No.: US 2019/0226161 A1
(43) Pub. Date: Jul. 25, 2019

(54) FUNCTIONALIZED FILAMENT AND ARTIFICIAL TURF PREPARED THEREFROM, AND METHODS FOR MAKING THE SAME

(71) Applicant: TARKETT INC., Farnham (CA)

(72) Inventor: Abhiram Kannan, Calhoun, GA (US)

(21) Appl. No.: 15/875,585

(22) Filed: Jan. 19, 2018

(51) Int. Cl. E01C 13/08; C08F 10/02; C08F 255/02; C08F 10/06; C08F 8/46; D01F 8/06

(52) U.S. Cl. CPC E01C 13/08; C08F 10/02; D01F 8/06; C08F 10/06; C08F 8/46; C08F 255/02

(57) ABSTRACT

The present application provides a functionalized filament for artificial turf, a method of manufacturing said filament and a field of artificial turf in which said filament is incorporated. The functionalized filament for artificial turf comprising polyolefin, such as polyethylene or polypropylene, and a compatibilizer that has a high affinity with polyurethane. The compatibilizers can be distributed in the filament uniformly or non-uniformly. The compatibilizer comprises a polyolefin polymer functionalized with various functional groups or their derivatives, such as amine, imide, hydroxyl, acid, anhydride, or acrylic.

### FIELD OF THE INVENTION

The present application discloses a functionalized filament for artificial turf, a method of manufacturing said filament and a field of artificial turf in which said filament is incorporated. The functionalized filament comprises polyolefin, such as polyethylene or polypropylene, and a compatibilizer that has a high affinity with polyurethane.

### BACKGROUND OF THE INVENTION

Artificial turf is commonly made of a synthetic turf system comprising at least three components, including fibers, infill and backing. Artificial turf fibers provide comfort and safety with a grass-like look and are commonly made of polyolefin in the structures of the filaments including slit-films or monofilaments, such as a polyethylene or polypropylene monofilament. Artificial turf infill systems typically comprise infill materials (e.g., sand or crumb rubber) which are spread between the fibers to provide appropriate cushioning. Artificial turf backing may comprise a main or primary backing and an adhesive (or secondary backing). The primary backing may comprise a woven fabric made of polyolefin, such as a polypropylene woven fabric. The artificial turf fibers are tufted into the primary backing. Then, the artificial turf fibers are secured by applying an adhesive, such as a polyurethane coating, on the underside of the primary backing. The primary backing or adhesive may include multiple layers or components (e.g., additional layers or a layer may contain sublayers).

Polyolefins, such as polyethylene or polypropylene, generally are relatively more nonpolar and have relatively poor adhesion and compatibility with polar polymers or substrates, such as polyurethane. Since the polyolefin filament and the polyurethane coating are inherently incompatible, the incompatibility causes the contact regions between polyolefin and polyurethane to be points of weakness. The points of weakness can manifest as loose fibers of the artificial turf in the form of filaments being easily pulled out of the polypropylene woven fabric.

Existing systems or processes, however, have disadvantages and/or have not been found to sufficient technical performance capabilities.

### SUMMARY OF THE INVENTION

The present application provides a functionalized filament for artificial turf comprising a polyolefin polymer and a compatibilizer that has a high affinity with polyurethane, wherein the compatibilizer comprises a functionalized-polyolefin polymer which is functionalized with a functional group or a derivative of the functional group, wherein the functional group is amine, imide, hydroxyl, acid, anhydride, or acrylic and wherein a concentration of the compatibilizer in the functionalized filament is in the range of from 1.5% wt to 13% by wt. based on combined weights of the polyolefin polymer and the compatibilizer (as used herein “wt” or “by wt. is in reference to this relationship). In one embodiment, the concentration of the compatibilizer in the functionalized filament is in the range of from 2% wt to 5.5% wt.

In another embodiment, the functionalized filament for artificial turf comprises polyolefin polymer, such as polyethylene or polypropylene, and a compatibilizer that has a high affinity with polyurethane, wherein the compatibilizers can be distributed in the filament either uniformly or non-uniformly, wherein the filament can be a multicomponent filament. The compatibilizers can be distributed uniformly by applying a process in which the compatibilizers is mixed or blended with the polyolefin to provide a general even distribution. A non-uniform distribution can also be possible for example by performing a limited duration of blending.

The compatibilizer of the functionalized filament of the present application comprises a polyolefin polymer functionalized with various functional groups or their derivatives, such as amine, imide, hydroxyl, acid, anhydride or acrylic. In a preferred embodiment, the functional group is an anhydride derived from maleic acid, such as maleic anhydride. In this embodiment, the compatibilizer comprises polyolefin polymer chains modified with anhydride functional groups. The concentration of the compatibilizer in the functionalized filament is in the range of from 2% wt to 13% wt based on the total weight of the functionalized filament, i.e., the combined weights of polyolefin and compatibilizers. The weight of the compatibilizer includes the weights of the modified polyolefin polymer and the functional groups. In a preferred embodiment, the concentration of the compatibilizer in the functionalized filament is at least 2%. In another preferred embodiment, the concentration of the compatibilizer in the functionalized filament is in the range of from 2% to 5.5%.

The present application also provides a method for making an artificial turf, comprising tufting fibers into a primary backing, spreading an infill system between the fibers, securing the fibers to the primary backing by spreading a polyurethane coating on the underside of the primary backing, wherein the fiber is made of the functionalized filament of the present application. In a preferred embodiment, the primary backing is a woven fabric made of polypropylene. In another embodiment, the primary backing is a woven fabric made of polyester. In another embodiment, the primary backing is a woven fabric made of polypropylene and possessing needle punched polyester or polypropylene fibers. In one aspect, the primary backing is a woven fabric made of polypropylene, polyester, possessing needle punched polyester, or combinations thereof. The present application also provides an artificial turf that is made by the method of the present application by incorporating the functionalized filaments of the present application.

In yet another aspect, the present application provides functionalized filament for artificial turf comprising a polyolefin polymer and a compatibilizer that has a high affinity with polyurethane, wherein the compatibilizer comprises a functionalized-polyolefin polymer which is functionalized with a functional group or a derivative of the functional group, wherein the functional group is amine, imide, hydroxyl, acid, anhydride, or acrylic, wherein the functionalized filament comprises an outermost sheath layer and an inner core layer, wherein the outermost sheath layer comprises the compatibilizer, wherein the inner core layer does not comprise the compatibilizer. In one embodiment, the concentration of the compatibilizer in the outermost sheath layer is in the range of from 2% wt to 10% (2.5% wt to 10.5% wt for single component) wt based on combined weights of the polyolefin polymer and the compatibilizer. Even in the single component filament, it should be understood that the objective is to have a concentration of 2% wt to 10% wt in the outer area of the single component structure. As mentioned herein, 0.5% is added to composite for the structural difference.

In addition, the present application provides a functionalized filament for artificial turf comprising a polyolefin polymer and a compatibilizer that has a high affinity with polyurethane, wherein the compatibilizer comprises a functionalized-polyolefin polymer which is functionalized with a functional group or a derivative of the functional group, wherein the functional group is amine, imide, hydroxyl, acid, anhydride, or acrylic, wherein the functionalized filament comprises an outermost sheath layer and an inner core layer, wherein the outermost sheath layer comprises the compatibilizer, wherein the inner core layer does not comprise the compatibilizer, and wherein a concentration of the compatibilizer in the outermost sheath layer is in the range of from 2% wt to 10% wt based on combined weights of the polyolefin polymer and the compatibilizer. In one embodiment, the functionalized filament contains multiple sheath layers and core layers, wherein the fiber comprises at least two components, wherein the outermost sheath layer comprises polyolefin, such as polyethylene or polypropylene, and a compatibilizer that has a high affinity with polyurethane, wherein the inner sheath and core layers comprise polyolefin polymers, such as polyethylene, polypropylene or their blends. In a preferred embodiment, the functionalized multicomponent fiber comprises 2-6 components. In another preferred embodiment, the functionalized multicomponent fiber comprises two components.

The compatibilizer in the outermost sheath layer of the functionalized multicomponent fiber of the present application comprises a polyolefin polymer functionalized with various functional groups or their derivatives, such as amine, imide, hydroxyl, acid, anhydride, or acrylic. In a preferred embodiment, the functional group is an anhydride derived from maleic acid, such as maleic anhydride. In this embodiment, the compatibilizer comprises polyolefin polymer chains modified with anhydride function groups. The concentration of the compatibilizer in the outermost sheath layer of the functionalized multicomponent fiber is in the range of from 2% wt to 10% wt based on the total weight of the outermost sheath layer, i.e., the combined weights of polyolefin and compatibilizer in the outermost sheath layer. The weight of the compatibilizer includes the weights of modified polyolefin polymer and functional groups. In a preferred embodiment, the concentration of the compatibilizer in the outermost sheath layer is at least 2% wt. In another preferred embodiment, the concentration of the compatibilizer in the outermost sheath layer is in the range of from 2% wt to 5% wt.

The present application also provides a method for making an artificial turf, comprising tufting fibers into a primary backing, spreading an infill system between the fibers, securing the fibers to the primary backing by spreading a polyurethane coating on the underside of the primary backing, wherein the fiber is made of the functionalized multicomponent fiber of the present application. In a preferred embodiment, the primary backing is a woven fabric made of polypropylene. In another embodiment, the primary backing is a woven fabric made of polypropylene and polyethylene terephthalate (PET). In another embodiment, the primary backing is a woven fabric made of polypropylene and possessing needle punched PET fibers. In one aspect, the primary backing is a woven fabric made of polypropylene, polyethylene terephthalate, possessing needle punched polyethylene terephthalate, or combinations thereof. The present application also provides an artificial turf, which is made by the method of the present application by incorporating the functionalized multicomponent fibers of the present application.

The details of the preferred embodiments of the present application are set forth in the accompanying figures and detailed description herein. Once these details of the application are known, numerous additional innovations and changes, which are within the scope of this application, will become obvious and implementable to one of ordinary skill in the art.

### BRIEF DESCRIPTION OF THE FIGURES

Further features of the inventive concept, its nature and various advantages will be more apparent from the following detailed description, taken in conjunction with the accompanying figures:

FIG. 1 shows a magnified view of a cross section of an illustrative multicomponent filament fiber comprising a core layer and a sheath layer, wherein the compatibilizer is present only in the sheath layer of a multicomponent filament in accordance with embodiments of the present invention. The distribution of the compatibilizers in the sheath layer is illustratively represented by the dots but it is not necessarily to scale.

FIG. 2 shows a magnified view of a cross section of an illustrative monofilament fiber, wherein the compatibilizers are incorporated throughout the cross section of the monofilament fiber in accordance with embodiments of the present invention. The distribution of the compatibilizers in the monofilament fiber is illustratively represented by the distribution of the dots, but it is not necessarily to scale.

### DETAILED DESCRIPTION OF THE INVENTION

Throughout this description, the preferred embodiments and examples provided herein should be considered as exemplar, rather than as limitations of the present application.

The present application discloses a functionalized filament for artificial turf, a method of manufacturing said filament and an artificial turf (e.g., a field made of artificial turf, the assembled backing and fibers prior to installation e.g., without infill) in which said filament is incorporated.

Polyolefin polymers, such as polyethylene and polypropylene, are used to manufacture yarns or fibers for producing artificial turf in order to achieve improved wear-resistance, flexibility, mechanical properties and processability. In one embodiment, polyolefin polymers are extruded to form filaments and further processed into bands. Several bands are twisted to form a yarn. Several yarns may be twined to form a composite yarn. In some embodiments, co-extrusion is used to manufacture the yarns, such as building a core and a cladding. In some embodiments, a multicomponent fiber comprising a sheath and a core is made of polyethylene filaments. A multicomponent in this context refers to the structure of the fiber being made of two or more layers (e.g., a core and an outer layer).

In order to improve the compatibility between polyolefin polymers and polar substrates, such as polyurethane, a compatibilizer is introduced into the polyolefin polymers during extrusion. The present application provides a functionalized filament for artificial turf, which is made of polyolefin polymers, such as polyolefin blend compositions containing functionalized polyolefin polymers as compatibilizers. In one embodiment, a compatibilizer, such as a maleic acid derivative of polyethylene, is introduced into the polyethylene filament during the manufacturing extrusion process. In a preferred embodiment, the maleic acid derivative is maleic anhydride. The compatibilizer is introduced into the polyethylene filament during the manufacturing extrusion process to be distributed throughout the filament (or layer, as it should be understood in a multicomponent structure) from which a functionalized polyethylene filament can be obtained. In some embodiments, a single component fiber is made of polyethylene filament comprising compatibilizers, wherein some of the compatibilizers are situated on the surfaces of the fibers to maximize the compatibility between the fiber and the polyurethane coating. In some embodiments, a multicomponent fiber comprising a sheath and a core is made of polyethylene filament comprising compatibilizers. In a preferred embodiment, a multicomponent fiber comprising a sheath and a core is made of polyethylene filament comprising compatibilizers, wherein the sheath comprises compatibilizers, wherein the core does not comprise compatibilizers. In a preferred embodiment, a multicomponent fiber comprising multiple sheaths and cores is made of polyethylene filament comprising compatibilizers, wherein the outermost sheath comprises compatibilizers, wherein the inner sheath and core do not comprise compatibilizers.

In one embodiment, a modified polyethylene filament is obtained by introducing the compatibilizers into the polyethylene filament during the manufacturing extrusion process to distribute the compatibilizers throughout the polyethylene filament. When the surfaces of the modified polyethylene filaments are contacted with a polyurethane coating, the affinity between the modified polyethylene filament and the polyurethane coating is much higher than that of the unmodified polyethylene filament by several orders of magnitude. The increased affinity promotes the penetration of the polyurethane into the filament bundle and improves the adhesion between the polyethylene filament and the polyurethane coating to secure the polyethylene filament in place.

The present application provides a functionalized filament for artificial turf, which is made of polyolefin blend compositions containing functionalized polyolefin polymers as compatibilizers. A modified polyethylene filament is obtained by introducing the compatibilizers into the polyethylene filament during the manufacturing extrusion process to distribute the compatibilizers throughout the polyethylene filament. The modified polyethylene filament has excellent adhesion properties toward polar polymers or substrates, such as polyurethane, when polyolefin blend compositions containing at least 2% wt functionalized polyolefin polymers (i.e., compatibilizers), preferably in the range of from 2% wt to 5.5% wt, 2% wt to 10.5%, or from 2% wt to 13% wt based on the combined weights of the polyolefin polymers and functionalized polyolefin polymers.

The polyolefin in the polyolefin blend compositions of the present application can for example include high density polyethylene (HDPE), low density polyethylene (LDPE), metallocene linear low density polyethylenes (LLDPE), homogeneously branched linear ethylene/α-olefin interpolymers, homogeneously branched substantially linear ethylene/α-olefin interpolymers, or combinations thereof.

### EXAMPLE

The following examples illustrate the benefits and advantages of the present application.

### Example 1. The Addition of Compatibilizers in Multicomponent Filaments

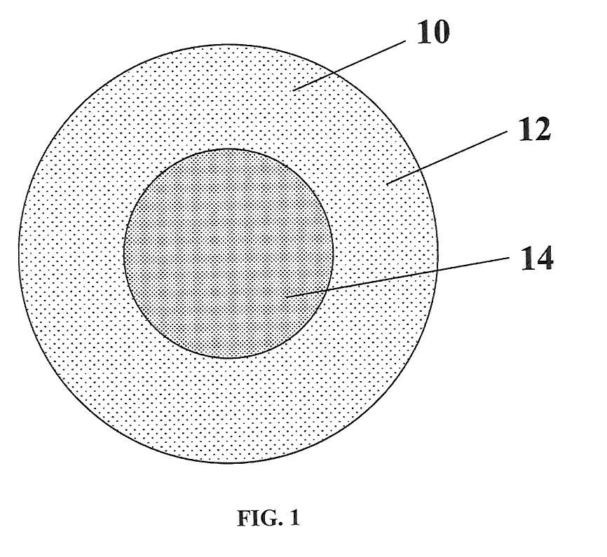

A series of multicomponent fiber filaments comprising a core layer (14) and a sheath layer (10) were made using extrusion, wherein the compatibilizer was present only in the sheath layer of a multicomponent filament. The distribution of the compatibilizers in the sheath layer (10) is illustratively represented by the distribution of the dots (12), not necessarily to scale (meaning it may show greater density than actual for illustration purposes), in FIG. 1. A series of bicomponent filaments having a cross section as shown in FIG. 1 were extruded using two or three grades of Linear Low Density Polyethylene (“LLDPE”) polymers, i.e. LLDPE1, LLDPE2, or LLDPE-g-MA. Linear Low Density Polyethylene grafted with Maleic Anhydride (LLDPE-g-MA) was purchased from Sigma-Aldrich. The core layer is made of LLDPE1 (a linear low density polyethylene having a density of 0.92 gm/cc as per ISO 1183 and a melt index of 0.5 gm/10 min as per ISO 1133) at a fixed loading weight percentage of 45%. The sheath layer is made of LLDPE2 (a linear low density polyethylene having a density of 0.92 gm/cc as per ISO 1183 and a melt index of 0.9 gm/10 min as per ISO 1133) in the range of from 37.5% to 55% and LLDPE-g-MA in the range of from 0% to 17.5%. The formulations of LLDPE1, LLDPE2 and LLDPE-g-MA for the series are provided in Table 1.

TABLE 1
Bicomponent filament formulations

| | Core | Sheath | |
|---|---|---|---|
| Iteration | Wt % LLDPE 1 | Wt % LLDPE 2 | Wt % LLDPE-g-MA |
| 1 | 45 | 55 | 0 |
| 2 | 45 | 53 | 2 |
| 3 | 45 | 50 | 5 |
| 4 | 45 | 47.5 | 7.5 |
| 5 | 45 | 45 | 10 |
| 6 | 45 | 42.5 | 12.5 |
| 7 | 45 | 40 | 15 |
| 8 | 45 | 37.5 | 17.5 |

The produced series of bicomponent filaments were incorporated to turf carpet by first tufting the filaments onto a primary backing made of polypropylene woven fabric, and subsequently the primary backing was coated with polyurethane adhesive. The weight of the polyurethane coating applied to the primary backing was between 16 and 22 oz per sq yard of turf.

The strength at the point of contact between polyurethane (PU) and polyethylene (PE) filaments was quantified in a standard test by measuring the force (in lbf) required to release a single filament from the turf backing. When the force was applied on an individual filament, there were two results. The filament was released from the turf by leaving a clean break at the point of contact, or alternatively the filament slipped out from the turf in its entirety. This test was repeated a hundred times per each iteration, noting each time if a filament broke or slipped from the turf i.e. at the point of PU-PE fiber contact. The statistics of the number of breaks and slips including the average values and standard deviations for the break force and slip force (lbf) are provided in Table 2.

TABLE 2
Statistical results for the single filament pull tests conducted
on the bicomponent filaments that were prepared based on
the formulations as described in Table 1.

| Wt % | | |
|---|---|---|
| LLDPE-g- | No. of Slips | No of Breaks |
| MA | (Per 100 pulls) | (Per 100 pulls) |
| 0 | 100 | 0 |
| 2 | 92 | 8 |
| 5 | 75 | 25 |
| 7.5 | 66 | 34 |
| 10.0 | 64 | 36 |
| 12.5 | 52 | 48 |
| 15.0 | 46 | 54 |
| 17.5 | 39 | 61 |

The data in Table 2 illustrates the relationship between the wt % of the compatibilizer (i.e., LLDPE-g-MA) and physical performance at the point of contact between PE and PU. With the incorporation of the compatibilizer, the propensity of filaments to slip out is diminished. At 5% loading of the compatibilizer (LLDPE-g-MA), 25% of the filaments tested showed no slippage. In other words, 25% of the filaments tested did not slip out from the turf in their entirety, instead these filaments were released from the turf by leaving clean breaks at the point of PU-PE contact (i.e., number of breaks). This data was referring to number of breaks per 100 pulls in Table 2. Since the tested filaments were strongly affixed in the turf, the applied force was strong enough to break these filaments at the point of PE-PU contact. Note also the results at 2% by weight is considered to be significant by those of ordinary skill in the art given that the low loading provided performance improvements that were unexpected.

The trend continued with increasing loading wt % of the compatibilizer. At 17.5% loading of the compatibilizer, the majority of the filaments stay strongly affixed in the turf with only 39% of the filaments opting to slip out from the turf during testing.

### Example 2. The Addition of Compatibilizer in Single Component Monofilament Fibers

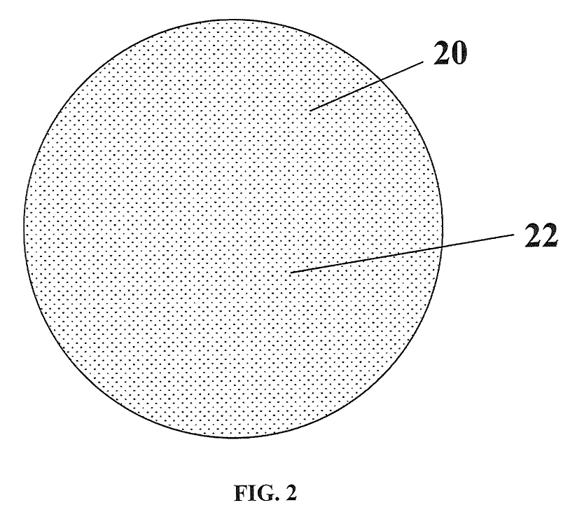

Seven different grades of polyethylene copolymers functionalized with amine, imide, hydroxyl, acid, anhydride or acrylic groups as described in Table 3 were procured from different industrial and academic suppliers. Grades 1A and 1B were both low density polyethylene (LDPE) copolymers, having a density of 0.85 gm/cc. Grade 1A was functionalized using amine. Grade 1B was functionalized using imide. Both Grades 1A and 1B were obtained from Sigma Aldrich. Grades 1C through 1F were copolymers of linear low density polyethylene (LLDPE) having a density range between 0.9 and 0.92 gm/cc, which were obtained from industrial suppliers. Grade 1G was an acrylic ester based polyethylene copolymer. A series of monofilament fibers were made through extrusion using these functionalized polyethylene copolymers as compatibilizers, wherein the compatibilizers were incorporated throughout the monofilament fiber (20) as shown in FIG. 2. The distribution of the compatibilizers in the monofilament fiber is illustratively represented by the distribution of the dots (22), not necessarily to scale, in FIG. 2.

Monofilament fibers having a cross section depicted in FIG. 2 were extruded by incorporating 5% of the respective compatibilizer grades of polyethylene copolymers and 95% LLDPE2 (a linear low density polyethylene having a density of 0.92 gm/cc as per ISO 1183 and a melt index of 0.9 gm/10 min as per ISO 1133). Seven iterations of functionalized filaments were produced by extrusion using Grades 1A-1G of functionalized polyethylene copolymers respectively. An 8^{th} control grade of polyethylene copolymer having the same geometry as other grades was produced without incorporating any compatibilizer.

The extruded monofilaments were incorporated to turf carpet by tufting onto a primary backing made of polypropylene woven fabric, and then a second step of polyurethane coating was applied to the underside of the carpet, i.e., onto the underside of the primary backing. The weight of the polyurethane coating applied was maintained between 16 and 22 oz per sq yard of turf. The strength at the point of contact between polyurethane and the turf filaments was quantified in a standard test by measuring the force (lbf) required to release a single filament out of the turf. This test was repeated a hundred times per each iteration, noting each time if a filament broke or slipped out from the turf i.e., at the point of PU-PE (polyurethane-polyethylene) contact. The statistics of the number of breaks and slips including the average values and standard deviations for the break force and slip force (lbf) are provided in Table 4.

TABLE 3
Grades and characteristics of compatibilizers

| Iteration | Grade | Carrier Resin | Functional Group | Weight % added |
|---|---|---|---|---|
| 1 | 1A | LDPE | Amine | 5% |
| 2 | 1B | LDPE | Imide | 5% |
| 3 | 1C | LLDPE | Hydroxyl | 5% |
| 4 | 1D | LLDPE | Acid | 5% |
| 5 | 1E | LLDPE | Anhydride | 5% |
| 6 | 1F | LLDPE | Anhydride | 5% |
| 7 | 1G | Ethylene | Acrylic | 5% |
| | | Acrylic Ester | | |

TABLE 4
Statistical results for the single filament pull tests conducted on the
monofilament fibers that were prepared based on the formulations
as described in Table 3.

| | Avg | Std Dev | | |
|---|---|---|---|---|
| | Slip Force | Slip Force | No of Slips | No of Breaks |
| Grade | (lbf) | (lbf) | (Per 100 Pulls) | (Per 100 Pulls) |
| Control | 2.94 | 0.62 | 100 | 0 |
| 1A | 3.08 | 0.56 | 46 | 54 |
| 1B | 3.05 | 0.45 | 43 | 57 |
| 1C | 3.41 | 0.48 | 58 | 42 |
| 1D | 3.31 | 0.43 | 37 | 63 |
| 1E | 3.27 | 0.53 | 50 | 50 |
| 1F | 3.57 | 0.58 | 67 | 33 |
| 1G | 3.85 | 0.45 | 60 | 40 |

The data in Table 4 shows the impact of each of the different grades toward improving the resistance to slip at the point of contact between PE filaments and PU coating. Addition of 5% wt of the compatibilizer increased the average force required to release a filament from the turf when compared to the control filament without the addition of compatibilizer. The least improvement over the control is observed in fibers based on 5% 1A and 1B grades respectively, while the most improvement at 5% loading is exhibited by filaments based on 1D, 1F and 1G grades. Fibers based on the other grades fall between these two extremes. All grades show a statistically significant improvement in resistance to filament pull out.

As illustratively described herein, the addition of a functionalized-polyolefin polymer provides performance improvements at a lower percentage or a lower range of percentages by weight than what expected. It was not expected to see improvements in performance at a low rate(s) such as at 2% by wt, 5% by wt, 7.5% by wt, 10% by wt, or 12.5% by wt (% wt of compatibilizer in a functionalized filament). It was also not expected to see such significant performance improvement at 5% by wt. This is shown in the provided test data and results. It is also reasonable to infer an appropriate low range that is effective from this information such as 2% to 13%, 2% to 10.5%, 2% to 8%, 2% to 5.5%, 5% to 7.5%, and 5% by wt (of compatibilizer in the functionalized filament). A value recited herein for the percentage by weight of compatibilizer is understood to be associated with a small percentage of variation so that it incorporates an approximation of +/20%, such as 5%+/−20% (of the 5%). The artificial filament can be a filament that comprises a polyolefin polymer and a compatibilizer comprising a functionalized-polyolefin polymer which is functionalized with a functional group or derivative of a functional group, wherein the functional group is selected from the group: amine, imide, hydroxyl, acid, anhydride, or acrylic, and the functionalized polyolefin polymer has a concentration of compatibilizer in the functionalized filament in the range of 2% to 13%, 2% to 10.5%, 2% to 8%, 2% to 5.5%, 5% to 7.5%, and 5% by wt (of compatibilizer in the functionalized filament). In preferred embodiments, the compatibilizer is a functionalized polyolefin polymer which is functionalized with a functional group or derivative of the functional group wherein the functional group is selected from the group: amine, imide, hydroxyl, acid, anhydride, or acrylic.

It should be understood that in multicomponent fiber embodiment, the outer sheet or layer is functionalized to produce a functionalized filament. The illustrative description, examples, and testing involved a “single” component filament. In the case of a multicomponent filament, the outer layer having an exterior exposed surface that touches the primary backing and/or adhesive is formed to include the desired compatibilizer, as discussed herein (other layers can be produced without the compatibilizer if desired). In such an arrangement, the percentage by weight of the compatibilizer in the functionalized filament can be lower because the likely thinner outer layer will cause more of the compatibilizer to be on or close to the surface.

A recitation of a range should be understood to include the end points of the range. The percentage by weight is based on the total weight of the functionalized filament, i.e. the combined weights of polyolefin polymer and compatibilizers, which is the primary or substantially all of the material used in producing a filament. The filament is produced through polymer extrusion by mixing the polyolefin polymer and the compatibilizers in melting state. The concentration of the compatibilizer in the functionalized filament is in the range of from 2% wt to 13% wt based on the total weight of the functionalized filament, i.e., the combined weights of polyolefin and compatibilizers. The weight of the compatibilizer includes the weights of the modified polyolefin polymer and the functional groups. The composition can be blended using solids (based on the desired percentage by weight), melted, and blended.

Given that the experiments were directed to a bicomponent structure, a reasonable estimation has been made based on scientific knowledge to increase the percentage by weight of compatibilizer by 0.5% in the description herein when in context the discussion is applicable to filaments in general (single component filament and multicomponent filament).

The composition, structure, and manufacturing process of conventional artificial turf fibers or filaments are generally known to those of ordinary skill in the art. This for example includes the knowledge of the different components that are combined to produce a filament.

The shape, surface texture or feature (e.g., bumps), geometric attributes, or other aspects that can affect a cross-sectional profile of filament will not in general affect (improve, reduce, modify, etc.) the effectiveness of embodiments of the present invention (in providing better fiber retention).

It is understood that the present application is not to be limited to the exact description and embodiments as illustrated and described herein. To those of ordinary skill in the art, one or more variations and modifications will be understood to be contemplated from the present disclosure. Accordingly, all expedient modifications readily attainable by one of ordinary skill in the art from the disclosure set forth herein, or by routine experimentation therefrom, are deemed to be within the true spirit and scope of the invention as defined by the appended claims. It is understood by those of ordinary skill in the art that a broader or specific scope of invention based on the provided description or figures are contemplated without the need for explicit recitation in the current application.

It would be understood that the various sizes, materials, configurations and arrangements disclosed herein may be combined and constructed in any way that is feasible to create a new filament, artificial turf comprising the filaments, or process for making the filament for the field of artificial turf systems, in particular athletic fields. Unless defined otherwise, all technical and scientific terms used herein have same meaning as commonly understood by one of ordinary skill in the art to which this invention belongs. Also, as used herein and in the appended claims, the singular form “a”, “and”, and “the” include plural referents unless the context clearly dictates otherwise. To the extent, an order of process steps is described, one of ordinary skill in the art will be able to understand the order of steps may be varied (or steps eliminated) without the need for the application to explicitly explain such variations.

What is claimed is:

1. A functionalized filament for artificial turf comprising a polyolefin polymer and a compatibilizer that has a high affinity with polyurethane, wherein the compatibilizer comprises a functionalized-polyolefin polymer which is functionalized with a functional group or a derivative of the functional group, wherein the functional group is amine, imide, hydroxyl, acid, anhydride, or acrylic and wherein a concentration of the compatibilizer in the functionalized filament is in the range of from 2% wt to 13% wt based on combined weights of the polyolefin polymer and the compatibilizer.

2. The functionalized filament of claim 1, wherein the concentration of the compatibilizer is in the range of from 2% wt to 5.5% wt.

3. The functionalized filament of claim 1, wherein the polyolefin polymer is polyethylene or polypropylene.

4. The functionalized filament of claim 1, wherein the functional group is maleic anhydride.

5. A method for making an artificial turf, comprising tufting fibers into a primary backing, spreading an infill system between the fibers, securing the fibers to the primary backing by spreading a polyurethane coating on the underside of the primary backing, wherein the fiber is made of the functionalized filament of claim 1.

6. The method of claim 5, wherein the primary backing is a woven fabric made of polypropylene, polyester, possessing needle punched polyester, or combinations thereof.

7. An artificial turf made by the method of claim 5.

8. The functionalized filament of claim 1, wherein the filament is a multicomponent filament.

9. A functionalized filament for artificial turf comprising a polyolefin polymer and a compatibilizer that has a high affinity with polyurethane, wherein the compatibilizer comprises a functionalized-polyolefin polymer which is functionalized with a functional group or a derivative of the functional group, wherein the functional group is amine, imide, hydroxyl, acid, anhydride, or acrylic, wherein the functionalized filament comprises an outermost sheath layer and an inner core layer, wherein the outermost sheath layer comprises the compatibilizer, wherein the inner core layer does not comprise the compatibilizer, and wherein a concentration of the compatibilizer in the outermost sheath layer is in the range of from 2% wt to 13% wt based on combined weights of the polyolefin polymer and the compatibilizer.

10. The functionalized filament of claim 9, wherein the concentration of the compatibilizer is in the range of from 2% wt to 5.5% wt.

11. The functionalized filament of claim 9, wherein the polyolefin polymer is polyethylene or polypropylene.

12. The functionalized filament of claim 9, wherein the functional group is maleic anhydride.

13. A method for making an artificial turf, comprising tufting fibers into a primary backing, spreading an infill system between the fibers, securing the fibers to the primary backing by spreading a polyurethane coating on the underside of the primary backing, wherein the fiber is made of the functionalized filament of claim 9.

14. The method of claim 13, wherein the primary backing is a woven fabric made of polypropylene, polyethylene terephthalate, possessing needle punched polyethylene terephthalate, or combinations thereof.

15. An artificial turf made by the method of claim 13.
